(19) United States
(12) Patent Application Publication
(10) Pub. No.: US 2008/0174933 A1
(43) Pub. Date: Jul. 24, 2008

(54) Apparatus and Method to Store Electrical Energy

(75) Inventors: James Chyi Lai, Saint Paul, MN (US); Tom Allen Agan, Saint Paul, MN (US)

Correspondence Address: THOMAS, KAYDEN, HORSTEMEYER & RISLEY, L.L.P., 15th Floor, 600 Galleria Parkway, Atlanta, GA, 30339-5994, US

(73) Assignee: WESTERN LIGHTS SEMICONDUCTOR CORP., Saint Paul, MN (US)

(21) Appl. No.: 11/624,742

(22) Filed: Jan. 19, 2007

(51) Int. Cl. H01G 4/00

(52) U.S. Cl. 361/303

(57) ABSTRACT

An apparatus to store electrical energy has a first magnetic unit, a second magnetic unit, and a dielectric section. The first magnetic unit has a first magnetic section and a second magnetic section. The second magnetic unit has a third magnetic section and a fourth magnetic section. The dielectric section is configured between the first magnetic unit and the second magnetic unit. The dielectric section is arranged to store electrical energy, and dipoles of the first magnetic section, the second magnetic section, the third magnetic section, and the fourth magnetic section are arranged to prevent electrical energy leakage.

### BACKGROUND

1. Field of Invention

The present invention relates to an apparatus and method to store electrical energy. More particularly, the present invention relates to a magnetic device to store electrical energy.

2. Description of Related Art

Energy storage parts are very important in our life. Components such as capacitors used in the circuits and batteries used in portable devices, the electrical energy storage parts influence the performance and the working time of the electrical device.

However, traditional energy storage parts have some problems. For example, capacitors have a problem of current leakage decreasing overall performance. Batteries have the memory problem of being partially charged/discharged and decreasing overall performance.

The Giant Magnetoresistance Effect (GMR) is a quantum mechanical effect observed in structures with alternating thin magnetic and thin nonmagnetic sections. The GMR effect shows a significant change in electrical resistance from the zero-field high resistance state to the high-field low resistance state according to an applied external field.

Therefore, the GMR effect can be used to be the insulator with good performance. Thus, the apparatus with the GMR effect can be implemented to store electrical energy. For the foregoing reasons, there is a need to have an apparatus with the GMR effect to store electrical energy.

### SUMMARY

It is therefore an objective of the present invention to provide an apparatus and method to store electrical energy.

According to one embodiment of the present invention, the apparatus has a first magnetic unit, a second magnetic unit, and a dielectric section. The first magnetic unit has a first magnetic section and a second magnetic section. The second magnetic unit has a third magnetic section and a fourth magnetic section. The dielectric section is configured between the first magnetic unit and the second magnetic unit. The dielectric section is arranged to store electrical energy, and the first magnetic section, the second magnetic section, the third magnetic section, and the fourth magnetic section with dipoles are arranged to prevent electrical energy leakage.

According to another embodiment of the present invention, the apparatus to store electrical energy has several magnetic units each has two magnetic sections, and several dielectric sections respectively configured between two neighbor magnetic units. The dielectric sections are arranged to store electrical energy, and the magnetic sections with dipoles are arranged to prevent electrical energy leakage.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows an apparatus to store electrical energy according to an embodiment of the invention;

FIG. 2 shows the apparatus when the apparatus is charging according to an embodiment of the invention;

FIG. 3 shows the apparatus when the apparatus is discharging according to an embodiment of the invention; and

FIG. 4 shows the apparatus according to another embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

All figures are drawn for ease of explanation of the basic teachings of the present invention only; the extensions of the figures with respect to number, position, relationship, and dimensions of the parts to form the embodiment will be explained or will be within the skill of the art after the following description has been read and understood.

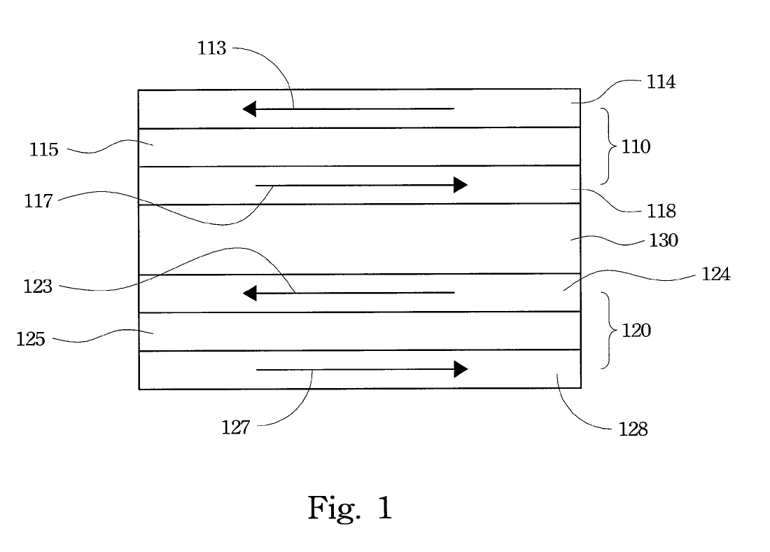

FIG. 1 shows an apparatus to store electrical energy according to an embodiment of the invention. The apparatus to store electrical energy has a first magnetic unit 110, a second magnetic unit 120, and a dielectric section 130. The first magnetic unit 110 has a first magnetic section 114 and a second magnetic section 118. The second magnetic unit 120 has a third magnetic section 124 and a fourth magnetic section 128. The dielectric section 130 configured between the first magnetic unit 110 and the second magnetic unit 120. The dielectric section 130 is arranged to store electrical energy, and the first magnetic section 114, the second magnetic section 118, the third magnetic section 124, and the fourth magnetic section 128 with dipoles (such as 113, 117, 123 and 127) are arranged to prevent electrical energy leakage.

The dielectric section 130 is a thin film, and the dielectric section 130 is composed of dielectric materials, such as BaTiO₃ or TiO₃. However, the dielectric material is not a perfect insulator. Some small amount of current passes through the dielectric section 130.

Therefore, the apparatus further has a first conductive section 115 configured between the first magnetic section 114 and the second magnetic section 118. The apparatus further has a second conductive section 125 configured between the third magnetic section 124 and the fourth magnetic section 128. The first conductive section 115 and the second conductive section 125 are arranged to be a conductor or an insulator by the control of the dipoles 113, 117, 123 and 127 of the magnetic sections 114, 118, 124, and 128.

Namely, two insulators, the first magnetic unit 110 and the second magnetic unit 120, are needed to prevent the current from passing through (i.e. electrical energy leakage). The first magnetic section 114, the second magnetic section 118, the third magnetic section 124, and the fourth magnetic section 128 are thin films, and these four magnetic sections with the dipoles are arranged to prevent electrical energy leakage.

The apparatus further has several metal devices (not shown) respectively disposed around first magnetic section 114, the second magnetic section 118, the third magnetic section 124, and the fourth magnetic section 128 to respectively control the dipoles 113, 117, 123 and 127 of the first magnetic section 114, the second magnetic section 118, the third magnetic section 124, and the fourth magnetic section 128. The designer or user can use the metal devices to apply external fields to control dipoles of the magnetic sections.

From the description above, the designer can control the dipoles 113, 117, 123 and 127 of the magnetic sections 114, 118, 124 and 128, and cooperate with the dielectric section 130 to store electrical energy and prevent electrical energy leakage. When the apparatus stores electrical energy, dipoles 113 ( [symbol] ) and 117 ( [symbol] ) of the first magnetic section 114 and the second magnetic section 118 in the first magnetic unit 110 are different, and dipoles 123 ( [symbol] ) and 127 ( [symbol] ) of the third magnetic section 124 and the fourth magnetic section 128 in the second magnetic unit 120 are different. Therefore, the first magnetic unit 110 and the second magnetic unit 120 prevent electrical energy leakage, and electrical energy can be stored in the dielectric section 130.

Namely, when dipoles 113 and 117 of the first magnetic unit 110 are different, and dipoles 123 and 127 of the second magnetic unit 130 are different, the first magnetic unit 110 and the second magnetic unit 120 become insulators. The current leakage is reduced thereby. When the current leakage is reduced, the energy is stored for a longer period of time and there is less loss of electrical energy.

It is noted that the symbols ‘ [symbol] ’ are arranged to represent the dipoles of the magnetic sections. The symbols ‘ [symbol] ’ are not arranged to restrict the dipole directions.

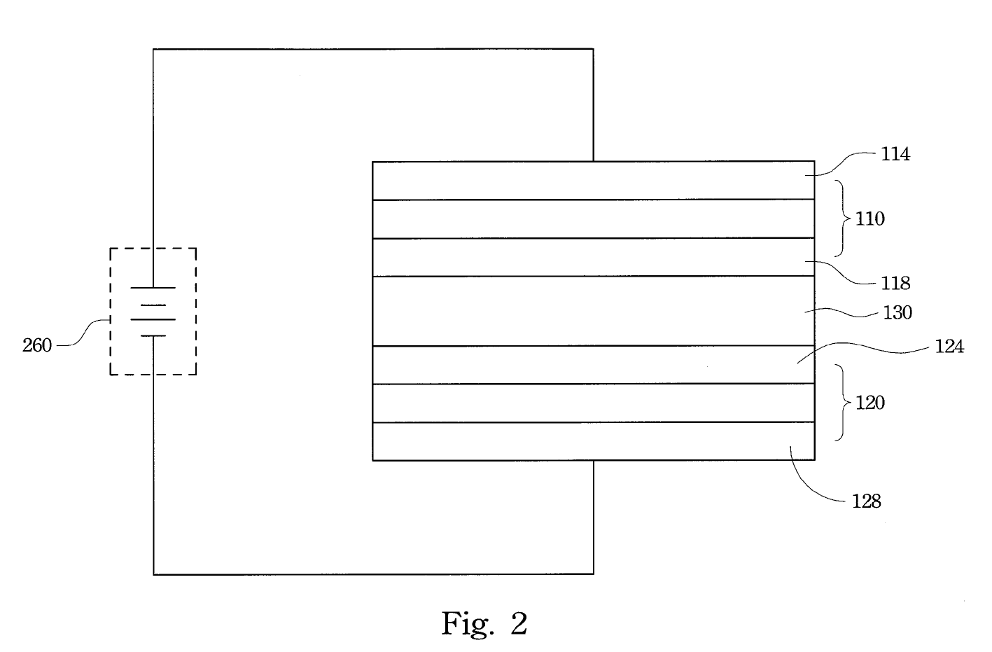

FIG. 2 shows the apparatus when the apparatus is charging according to an embodiment of the invention. When the apparatus is charged, the first magnetic unit 110 and the second magnetic unit 120 are coupled to a power source 260. The electrical energy can be inputted into the dielectric section 130 from the power source 260.

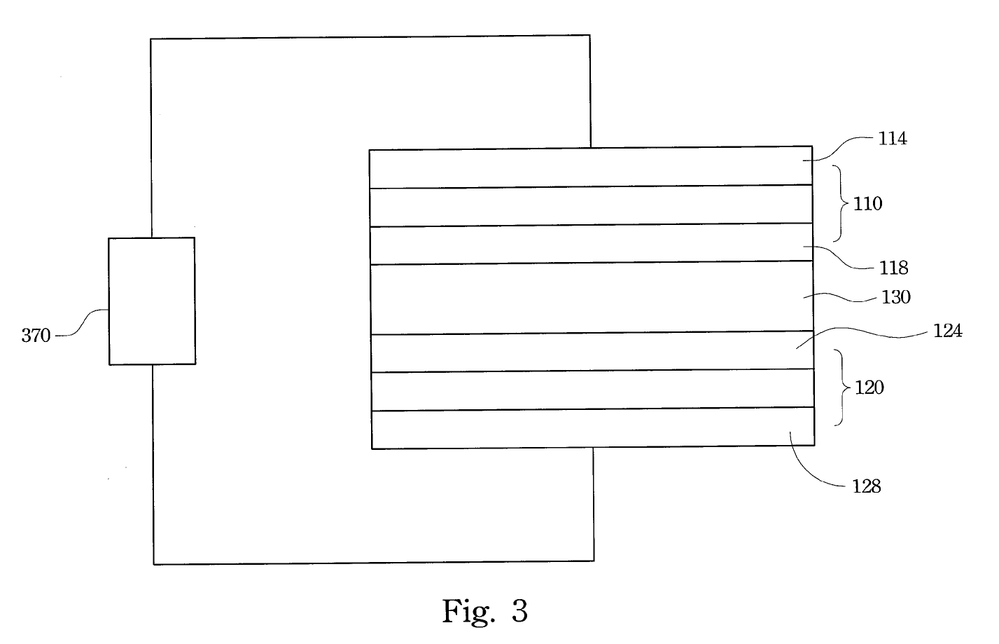

FIG. 3 shows the apparatus when the apparatus is discharging according to an embodiment of the invention. When the apparatus is discharged, the first magnetic unit 110 and the second magnetic unit 120 are coupled to a loading device 370. The electrical energy can be outputted from the dielectric section 130 to the loading device 370.

The power source or the loading device can influence the dipoles of the magnetic sections 114, 118, 124 and 128 easily, and the magnetic units 110 and 120 are not good insulators thereby. Therefore the current can be transmitted through the magnetic sections.

The apparatus can be viewed as a capacitor with large capacity. Moreover, the apparatus can be applied as a battery. The apparatus with a battery function should not have the memory problem. Therefore, the apparatus can be fully or partially charged/discharged without the loss of performance.

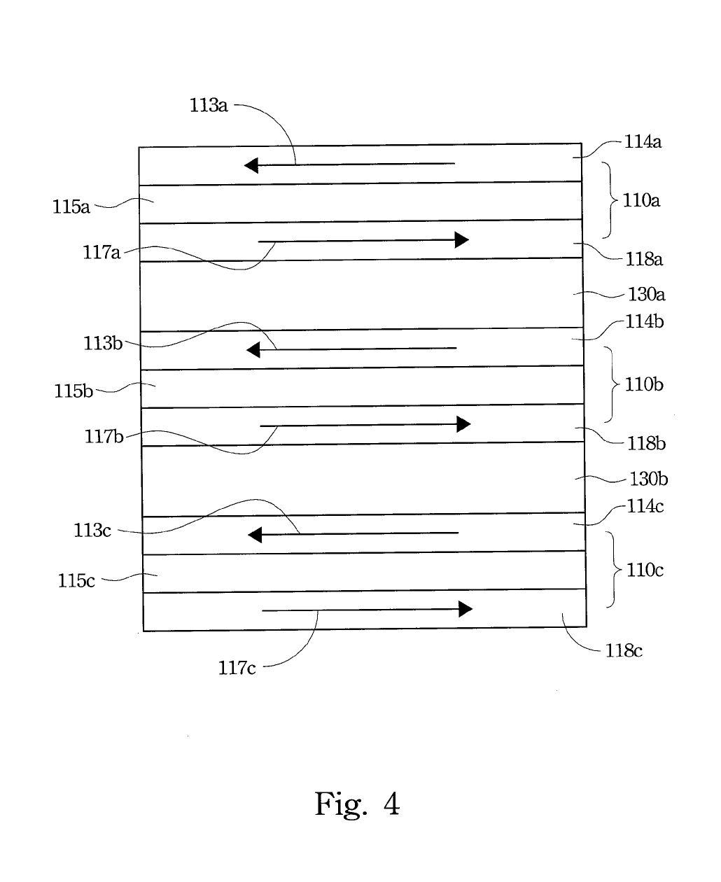

Otherwise, the apparatus can be used to create a large array in parallel to obtain much larger energy storage. Moreover, several apparatus can be stacked up to obtain much larger energy storage as shown in FIG. 4.

The embodiment in FIG. 4 takes three magnetic units 110a, 110b, 110c, and two dielectric sections 130a and 130b for example. The apparatus to store electrical energy has several magnetic units 110a, 110b and 110c, and several dielectric sections 130a and 130b. Each magnetic unit has two magnetic sections. Such as the magnetic units 110a has two magnetic sections 114a and 118a. The dielectric sections are respectively configured between two neighbor magnetic units. Such as the dielectric section 130a is configured between the neighboring magnetic units 110a and 110b; the dielectric section 130b is configured between the neighbor magnetic units 110b and 110c. The dielectric sections 130a and 130b are arranged to store electrical energy, and the magnetic sections 114a, 118a, 114b, 118b, 114c and 118c with dipoles 113a, 117a, 113b, 117b, 113c and 117c are arranged to prevent electrical energy leakage.

The apparatus further has several conductive sections respectively configured between these two magnetic sections of each magnetic unit. Such as the conductive sections 115a configured between the magnetic sections 114a and 118a in the magnetic unit 110a, and the conductive sections 115b is configured between the magnetic sections 114b and 118b in the magnetic unit 110b.

Moreover, the apparatus has several metal devices (not shown) respectively disposed around the magnetic sections to control dipoles of the magnetic sections.

When the apparatus stores electrical energy, the dipoles of these two magnetic sections of each magnetic unit are different. For example, when the apparatus stores electrical energy, the dipoles 113a and 117a of the magnetic sections 114a and 118a in the magnetic unit 110a are different, and the dipoles 113b and 117b of the magnetic sections 114b and 118b in the magnetic unit 110b are different.

When the apparatus is charged, the magnetic sections are partially coupled to a power source, and when the apparatus is discharged, the magnetic sections are partially coupled to a loading device. Namely, when the apparatus is charged or discharged, the magnetic sections 114a and 118c couple to the power source or the loading device, or all the magnetic sections couple to the power source or the loading device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus to store electrical energy, comprising:
a first magnetic unit with a first magnetic section and a second magnetic section;
a second magnetic unit having a third magnetic section and a fourth magnetic section; and
a dielectric section configured between the first magnetic unit and the second magnetic unit;
wherein the dielectric section is arranged to store electrical energy, and the first magnetic section, the second magnetic section, the third magnetic section, and the fourth magnetic section with dipoles are arranged to prevent electrical energy leakage.

2. The apparatus of claim 1, wherein the dielectric section is a thin film.

3. The apparatus of claim 1, wherein the dielectric section is composed of dielectric material.

4. The apparatus of claim 1, further comprising a first conductive section configured between the first magnetic section and the second magnetic section.

5. The apparatus of claim 1, further comprising a second conductive section configured between the third magnetic section and the fourth magnetic section.

6. The apparatus of claim 1, wherein each of the first magnetic section, the second magnetic section, the third magnetic section, and the fourth magnetic section is a thin film.

7. The apparatus of claim 1, further comprising a plurality of metal devices respectively disposed around the magnetic sections to respectively control the dipole of each of the magnetic sections.

8. The apparatus of claim 1, wherein when the apparatus stores electrical energy, the dipoles of the first magnetic section and the second magnetic section are different.

9. The apparatus of claim 1, wherein when the apparatus stores electrical energy, the dipoles of the third magnetic section and the fourth magnetic section are different.

10. The apparatus of claim 1, wherein when the apparatus is charged, the first magnetic unit and the fourth magnetic unit are coupled to a power source.

11. The apparatus of claim 1, wherein when the apparatus is discharged, the first magnetic unit and the fourth magnetic unit are coupled to a loading device.

12. An apparatus to store electrical energy, comprising:
a plurality of magnetic units each has two magnetic sections; and
a plurality of dielectric sections respectively configured between two neighbor magnetic units;
wherein the dielectric sections are arranged to store electrical energy, and the magnetic sections with dipoles are arranged to prevent electrical energy leakage.

13. The apparatus of claim 12, wherein the dielectric sections are a plurality of thin films.

14. The apparatus of claim 12, wherein the dielectric sections are composed of dielectric material.

15. The apparatus of claim 12, further comprising a plurality of conductive sections respectively configured between these two magnetic sections of each magnetic unit.

16. The apparatus of claim 12, wherein the magnetic sections are a plurality of thin films.

17. The apparatus of claim 12, further comprising a plurality of metal devices respectively disposed around the magnetic sections to respectively control the dipole of each of the magnetic section.

18. The apparatus of claim 12, wherein when the apparatus stores electrical energy, the dipoles of these two magnetic sections of each magnetic unit are different.

19. The apparatus of claim 12, wherein when the apparatus is charged, partially the magnetic sections are coupled to a power source.

20. The apparatus of claim 12, wherein when the apparatus is discharged, partially the magnetic sections are coupled to a loading device.
